(19) United States
(12) Patent Application Publication
(10) Pub. No.: US 2008/0205944 A1
(43) Pub. Date: Aug. 28, 2008

(54) BELT MEANDER PREVENTING DEVICE, TRANSFER UNIT AND IMAGE FORMING APPARATUS HAVING THE SAME

(75) Inventors: Se-ra LEE, Suwon-si (KR); Jeong-hwan Kim, Gunsan-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/838,310

(22) Filed: Aug. 14, 2007

(30) Foreign Application Priority Data
Feb. 27, 2007 (KR) 2007-19933

(51) Int. Cl. G03G 15/01

(52) U.S. Cl. 399/302

(57) ABSTRACT

A transfer unit of an image forming apparatus includes at least one support roller; a transfer belt driven and supported by the support roller; and a meander preventing unit to prevent the transfer belt from leaning to one side with respect to an axial direction of the support roller. The meander preventing unit includes a guide rail disposed between one side of the belt and the support roller supporting the belt to guide the belt running; and a belt pressing member disposed on the opposite side of the belt to compensate for the belt leaning caused by the guide rail.

### CROSS-REFERENCE TO RELATED APPLICATIONS

This application claims priority under 35 U.S.C. § 119 from Korean Patent Application No. 10-2007-0019933, filed on Feb. 27, 2007, in the Korean Intellectual Property Office, the entire content of which is incorporated herein by reference.

### BACKGROUND OF THE INVENTION

1. Field of the Invention

The present general inventive concept relates generally to a device to prevent a belt that moves on an endless track from meandering. More particularly, the present general inventive concept relates to a belt meander preventing device of an improved structure employed in a transfer unit of an image forming apparatus, the transfer unit and the image forming apparatus having the same.

2. Description of the Related Art

In general, an image forming apparatus, such as a laser color printer, transfers an image formed on a photoconductive medium onto a recording medium by use of an intermediate transportation medium. For example, the intermediate transportation medium mostly employs an intermediate transfer belt which moves in contact with the photoconductive medium. The intermediate transfer belt acquires an image of intended colors from the superposed color images transferred from the photoconductive medium. A final superposed image is transferred to a recording medium moving in contact with the intermediate transfer belt.

As the intermediate transfer belt drives in one direction while being supported by a plurality of support rollers including a drive roller and a tension roller, it serves to transfer the superposed color image onto the recording medium. The drive roller supplies power to drive the intermediate transfer belt. The tension roller regulates tension of the intermediate transfer belt. Since the length of the intermediate transfer belt changes depending on its use environment, the tension roller can drive with a certain tension while it rotates.

When the intermediate transfer belt is supported and driven by the drive roller and the tension roller, it may meander to one side because of mechanical error of the supporting roller. When the intermediate transfer belt leans to one side, the color image matching is problematic because of the repetitive rotation of the intermediate transfer belt at the wrong position, rather than at the predetermined position on the drive roller or the tension roller. Also, when the intermediate transfer belt drives for a long term at the wrong position, the unbalanced tension on the right and the left of the belt and the accumulated fatigue may cause severe cracks or damages. To prevent such problems, in the related art, a guide rail is disposed to complementarily contact both inner ends of the drive belt and both ends of the support roller supporting the drive belt. The guide rail disposed at both ends of the drive belt prevents the drive belt from leaning to one side with respect to the axial direction of the support roller and guides the support roller to run at a fixed position.

However, when the guide rail is provided at both ends of the drive belt as described above, the number of parts increases and thus the manufacturing costs increase. Since the guide rail is bonded to the belt by means of rubber adhesive such as silicon or urethane, the elasticity and the bending of the guide rail differ from those of the belt. Thus, as the belt continues to rotate, the adhesion gets weak and thus the bonded part may be detached. In addition, since the guide rail is adhered to the inside of the belt, its adhesion process is quite complicated.

The related art has attempted to decrease the number of parts by disposing of the guide rail at only one side of the drive belt, to address the problems caused by the adhesion of the guide rail, and to restrain the meander of the drive belt. FIG. 1 depicts a conventional belt meander preventing device which is disclosed in U.S. Pat. No. 5,017,969.

In FIG. 1, a guide groove 11 is formed on one end of a support roller 10. A guide rib 21 corresponding to the guide groove 11 is formed below a drive belt 20 which is supported by a support roller 10. As the guide rib 21 is guided and fitted in the guide groove 11, the drive belt 20 is prevented from meandering in the direction B1.

However, while the conventional guide rail, which is disposed only at one side of the drive belt 20, can decrease the number of parts and prevent meandering in the one direction B1, it is hard to protect the drive belt 20 from meandering in another direction B2. In detail, the drive belt 20 is subject to the meandering in the direction B2 because of the resultant force F3 of the tension F1 applied by the support roller 10 on the drive belt 20 and the control power F2 of the drive belt 20 moving in the direction B2 by the guide rails 11 and 21.

### SUMMARY OF THE INVENTION

The present general inventive concept provides a belt meander preventing apparatus having a simple structure to effectively prevent a belt meandering.

The present general inventive concept also provides a transfer unit of an image forming apparatus having a belt meander preventing device to address problems such as crack or damage to a belt because of tension unbalance of the left side and the right side of the belt.

The present general inventive concept provides an image forming apparatus having a transfer unit featured as above.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a belt shifting preventing device including a guide rail disposed between one end of a belt and one end of a support roller which supports the belt, to guide movement of the belt; and a belt pressing member disposed at an opposite side of the support roller to compensate for the belt shifting due to the guide rail.

The belt pressing member may exert a tensile force to the belt.

The guide rail may include a guide groove formed in the support roller in a ring shape; and a guide rib formed at the belt to correspond to the guide groove.

The guide rail may further include a flange formed at one end of the support roller to protrude higher than a circumference of the support roller.

The belt pressing member may include a reinforcing film disposed on the support roller with a certain width to form a step at the other side of the belt; and an adhesive to bond the reinforcing film onto the support roller.

The reinforcing film may be thinner than the belt and thicker than the adhesive.

The height of the belt pressing member may be approximately 70˜230 μm. The reinforcing film may have a thickness of approximately 40˜200 μm, and the adhesive may have a thickness of approximately 20˜100 μm.

The belt pressing member may include a protrusion integrally formed on the circumference of the support roller to form a step at the other side of the belt. The thickness of the protrusion may be less than the thickness of the belt.

The foregoing and/or other aspects and utilities of the present general inventive concept are also achieved by providing a transfer unit including at least one support roller; a transfer belt driven and supported by the support roller; and a meander preventing unit to prevent the transfer belt from meandering or shifting to one side with respect to an axial direction of the support roller, wherein the meander preventing unit comprises a belt pressing member disposed at the support roller to prevent the meandering or shifting of the transfer belt due to rotation of the support roller.

The meander preventing unit may further include a guide rail disposed between the transfer belt and the support roller to guide the movement of one side of the transfer belt.

The foregoing and/or other aspects and utilities of the present general inventive concept are also achieved by providing an image forming apparatus including a photoconductive medium on which a visible image is formed; a transfer unit including a transfer belt circumscribing the photoconductive medium and at least one support roller to support the transfer belt to move on an endless track; and a transfer belt meander preventing device as described above to prevent the transfer belt of the transfer unit from meandering or shifting to one side with respect to an axial direction of the support roller.

The foregoing and/or other aspects and utilities of the present general inventive concept are also achieved by providing an image forming apparatus including at least one photoconductive medium on which an electrostatic latent image is formed; a developing unit to develop the electrostatic latent image by transferring and attaching toners onto the electrostatic latent image of the photoconductive medium; and a transfer unit as described above to superpose and receive a visible image of the photoconductive medium,

The foregoing and/or other aspects and utilities of the present general inventive concept are also achieved by providing a method of preventing shifting of a transfer belt, the method comprising: guiding one side of the belt to rotate within a predetermined region while under tension; and pressing the belt at an opposite side thereof to compensate for the belt shifting due to the guiding operation.

### BRIEF DESCRIPTION OF THE DRAWINGS

These and/or other aspects and utilities of the present general inventive concept will become apparent and more readily appreciated from the following description of the exemplary embodiments, taken in conjunction with the accompanying drawings of which:

FIG. 1 is a simplified diagram of a conventional belt meander preventing device;

FIG. 2 is a simplified diagram of a transfer unit and an image forming apparatus including a belt meander preventing device according to an exemplary embodiment of the present general inventive concept;

FIG. 3 is a simplified diagram of the belt meander preventing device according to an exemplary embodiment of the present general inventive concept;

FIGS. 4 and 5 are enlarged views of important parts of FIG. 3;

FIG. 6 is an enlarged view of the right portion of FIG. 3; and

FIG. 7 is an enlarged view of important parts of a belt meander preventing device according to another exemplary embodiment of the present general inventive concept.

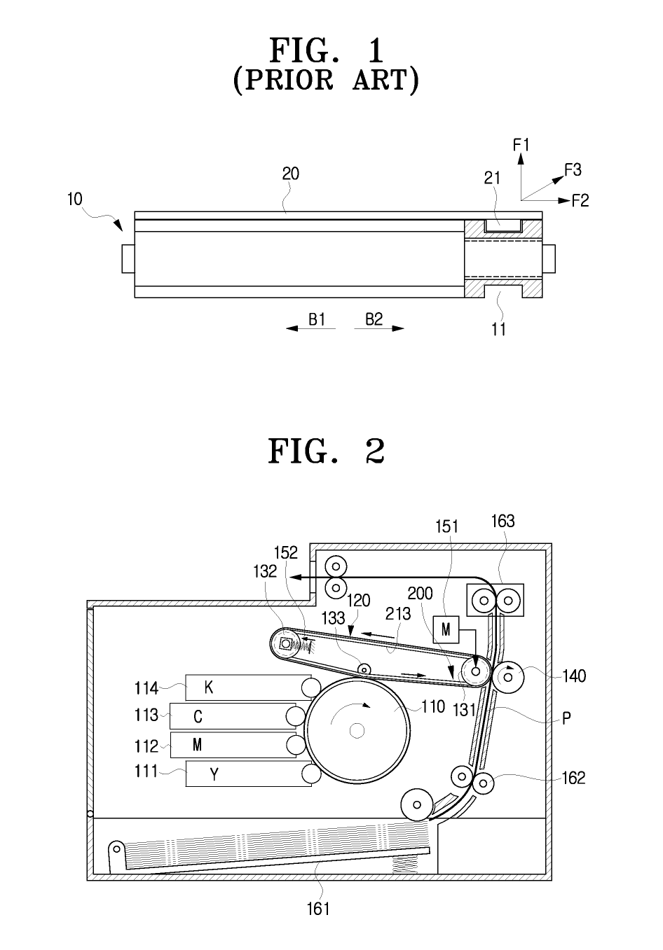

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An image forming apparatus of FIG. 2 includes a photoconductive medium 110, a belt 120 for first receiving an image formed on the photoconductive medium 110 (hereafter, referred to as an intermediate transfer belt), a plurality of support rollers 131 and 132 to support the intermediate transfer belt 120 to drive, a secondary transfer roller 140 installed to approach toward or recede from the intermediate transfer belt 120 to transfer an image from the intermediate transfer belt 120 onto a recoding medium, and a meander preventing unit 200 to prevent the intermediate belt 120 from meandering (or shifting) toward one side in the axial direction of the support rollers 131 and 132.

The photoconductive medium 110 is rotated by a primary transfer roller 133 with a primary transfer nip interposed between the photoconductive medium 110 and the intermediate transfer belt 120. Color developers 111,112,113 and 114 are sequentially disposed in the rotation direction of the photoconductive medium 110 to develop Y, M, C, and K colors onto the photoconductive medium 110 in order. Color images are formed on the photoconductive medium 1120 by the color developers 111 through 114, and the color images formed on the photoconductive medium 110 are superposed and transferred onto the intermediate transfer belt 120 in order.

The intermediate transfer belt 120 is supported by the support rollers 131 and 132 to rotate in one direction. One of the support rollers 131 and 132 is a drive roller 131 which rotates by a drive motor 151, and the other is a tension roller 132 which is pressed by a pressing member 152 such as spring, in an outer direction or other direction to regulate tension on the transfer belt 120. The tension roller 132 serves to press and support the intermediate transfer belt 120 to retain a constant tension of the intermediate transfer belt 120 by means of the pressing member 152. The tension roller 132 can be driven by the friction against the intermediate transfer belt 120 running by the power of the drive roller 131, or be rotated by the driving power through a gear train.

The color images superposed and transferred onto the intermediate transfer belt 120 are transported to a recording medium P which passes through a secondary transfer nip between the secondary transfer roller 140 and the intermediate transfer belt 120.

The recoding medium P is picked up from a feed cassette 161 of an image forming apparatus, aligned by a registration roller 162, and then fed to the secondary transfer nip. When the recording medium P passes through the second transfer nip, the images are transferred from the intermediate transfer belt 120 onto the recording medium P. Next, the recording medium P is delivered to a fixing unit 163. While passing through the fixing unit 163, the recording medium P is fixed by heat and pressure, and then discharged to an outside of the image forming apparatus.

It is very important to control the intermediate transfer belt 120, to which the color images from the photoconductive medium 110 are superposed and transferred, to stably run without meandering to one side, in order to superpose and transfer the color images over the correct position.

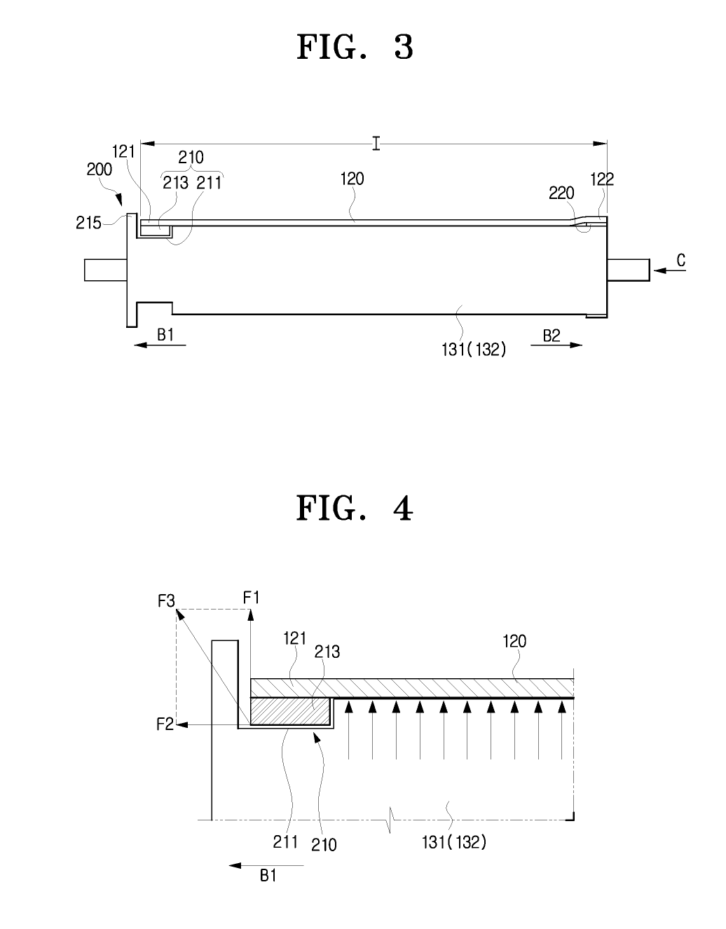

The meander (or shift) preventing unit 200 serves to prevent the intermediate transfer belt 120 from meandering (or shifting) in the axial direction of the rollers 131 and 132. Referring to FIG. 3, the meander preventing unit 200 includes a guide rail 210 disposed at one side of the intermediate transfer belt 120, and a belt pressing member 220 disposed at the other side of the intermediate transfer belt 120 and bonded onto the rollers 131 and 132.

The guide rail 210 includes a guide groove 211 formed at one end of the support rollers 131 and 132, and a guide rib 213 formed in an inner side of one side of the intermediate transfer belt 120 to be inserted into and guided by the guide groove 211. The guide groove 211 is formed to a certain depth and width from one end of the outer circumference of the support rollers 131 and 132. The guide rib 213 is bonded to the inner side of one side of the intermediate transfer belt 120 using an adhesive. Preferably, the guide rib 213 can be formed of urethane or silicon material to be flexible and deformable, like the intermediate transfer belt 120, but is not limited thereto.

It is advantageous that the guide rail 210 further includes a flange 215 which projects upward at one end of the support rollers 131 and 132 from the circumference of the support rollers 131 and 132. The flange 215, which corresponds to the outer wall of the guide groove 211, supports one side of the intermediate transfer belt 120.

In the guide rail 210 constructed as above, the guide rib 213 is thicker than the intermediate transfer belt 120 and the depth of the guide groove 211 is greater than the thickness of the guide rib 213. Accordingly, as stably running along the guide rail 210, the intermediate transfer belt 120 is prevented from meandering in the direction B2.

As illustrated in FIG. 4, the intermediate transfer belt 120 receives a tension F1 in the direction perpendicular to the moving direction due to the pressure from the tension roller 132. The mechanical structure of the guide rail 210, that is, the contact between the guide groove 211 and the guide rib 213 exerts a control force F2 in the axial direction of the roller 131. By virtue of the resultant force F3 of the tension F1 and the control force F2, the other end of the intermediate transfer belt 120 may meander in the direction B1.

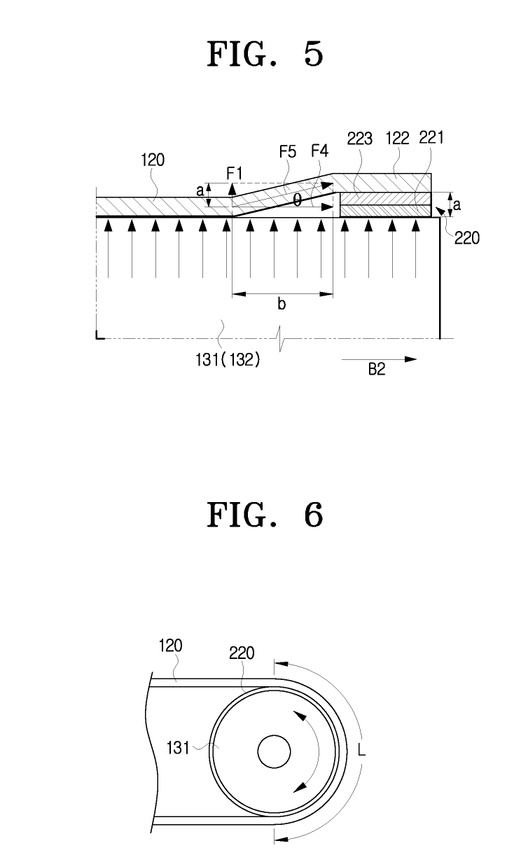

The belt pressing member 220 is provided to compensate for the leaning or shifting of the intermediate transfer belt 120 when the guide rail 210 is disposed only at one side due to the tension F1. The belt pressing member 220 includes a reinforcing film 223 disposed at an outer side of the other end of the rollers 131 and 132, and an adhesive 221 interposed between the reinforcing film 223 and the support rollers 131 and 132, as illustrated in FIG. 5. The reinforcing film 223 is bonded to the outer side of the rollers 131 and 132 using the adhesive 221, such as a double-sided tape or glue. The reinforcing film 223 is formed to a certain width and thickness less than the intermediate transfer belt 120. The thickness of the reinforcing film 223 is greater than that of the adhesive 221.

When the reinforcing film 223 is bonded onto the outer side of the other end 122 of the rollers 131 and 132, a step is formed at the other side 122 of the intermediate transfer belt 120. The step generates a tensile force F4 over the other side 122 of the intermediate transfer belt 120 in the direction B2. A resultant force F5 of the tensile force F4 and the tension F1 applied to the intermediate transfer belt 120 works in an opposing direction to the resultant force F3 applied to the guide rail 210, to thus prevent the intermediate transfer belt 120 from leaning or shifting toward the guide rail 210, that is, from meandering.

It is preferable that the reinforcing film 223 is a polyethylene terephthalate (PET) film. Alternatively, high polymer plastic film such as urethane, silicon, and poly carbonate (PC) or a metallic film can be used. It is preferable that the adhesive 221 is a double-sided tape or a glue. It is advantageous that the material of the intermediate transfer belt 120 is conductive polyimide (PI). Young's module of the intermediate transfer belt 120 is 2000 Mpa and its thickness ranges between 65˜85 μm.

The thickness of the adhesive 221 is about 30 μm or 20˜100 μm. The thickness of the adhesive 221 is constant regardless of the thickness of the reinforcing film 223. While the thickness of the reinforcing film 223 ranges between 20˜250 μm, 40˜400 μm is preferable in the experiments. Particularly, 40˜80 μm exhibits the satisfactory properties. With the constant thickness about 30 μm of the adhesive 221, by retaining the thickness 70˜120 μm of the belt pressing member 220, the tensile force that is enough to prevent the meandering of the intermediate transfer belt 120 can be produced. By contrast, when the thickness of the reinforcing film 221 is 20 μm less than 40 μm, a sufficient tensile power is not obtained. When the thickness of the reinforcing film 221 exceeds 200 μm, the stable running of the intermediate transfer belt 120 may not be guaranteed because of a mechanical problem.

Table 1 shows experimental results of the meandering when the intermediate transfer belt 120 runs with the thickness change of the reinforcing film 223.

TABLE 1

| | | | | | | | |
|---|---|---|---|---|---|---|---|
| Thickness | 30 μm | 30 μm | 30 μm | 30 μm | 30 μm | 30 μm | 30 μm |
| of adhesive | | | | | | | |
| Thickness | 20 μm | 40 μm | 60 μm | 80 μm | 100 μm | 200 μm | 250 μm |
| of reinforcing film | | | | | | | |
| Results of | NG | OK | OK | OK | OK | OK | NG |
| meandering | | | | | | | |

The results of Table 1 can be easily proved based on Equation 1 by calculating the tensile force generated from the thickness of the belt pressing member 220 and the step of the other end 122 of the intermediate transfer belt 120 from the other mechanical conditions by taking into account the properties of matter of the intermediate transfer belt 120.

F(tensile force)=A×E/(I×δ) [Equation 1]

Referring to FIGS. 5 and 6, in Equation 1,

A: the contact length L between the intermediate transfer belt 120 and the driving roller 132 in the rotational direction×the thickness T of the intermediate transfer belt 120

E: Young's module (2000 Mpa) of the intermediate transfer belt 120

I: the width of the intermediate transfer belt 120

δ: the extended length \sqrt{a²+b²−b} of the intermediate transfer belt 120, where b=a/tan θ

θ: the angle leaned by the step of the intermediate transfer belt 120

a: the thickness of the belt pressing member 220, and

b: the stepped distance of the intermediate transfer belt 120.

In Equation 1, it is assumed that the thickness T of the intermediate transfer belt 120 is 0.065 mm, E=2000 Mpa, A=47.2 mm×0.065 mm, I=240 mm, and θ=6.52°, which are constant regardless of the thickness of the reinforcing film 223.

On those conditions, when the thickness of the reinforcing film 223 is changed to 20 μm, 40 μm, 60 μm, 80 μm, 100 μm, 200 μm, and 250 μm, the magnitude of the tensile force by the step of the intermediate transfer belt 120 is calculated based on Equation 1 and illustrated in Table 2.

TABLE 2

| | Thickness of | | | | | | |
|---|---|---|---|---|---|---|---|
| | reinforcing film | | | | | | |
| | 20 μm | 40 μm | 60 μm | 80 μm | 100 μm | 200 μm | 250 μm |
| a (mm) | 0.05 | 0.07 | 0.09 | 0.11 | 0.13 | 0.23 | 0.28 |
| b (mm) | 0.4375 | 0.6125 | 0.7875 | 0.9625 | 1.13747 | 2.01244 | 2.44992 |
| δ (mm) | 0.00285 | 0.003987 | 0.005126 | 0.006265 | 0.0074 | 0.0131 | 0.01595 |
| F (N) | 0.073 | 0.102 | 0.131 | 0.160 | 0.1892 | 0.3349 | 0.4078 |

As illustrated in Table 1 and Table 2, when the tensile force generated by the belt pressing member 220 at the intermediate transfer belt 120 is over 0.1N at minimum under those conditions, the meandering can be avoided. On the condition that the thickness of the reinforcing film 223 is over 40 μm, the meander prevention works more effectively. When the thickness of the reinforcing film 223 exceeds 250 μm beyond 200 μm and the tension force produced by the belt pressing member 220 is greater than 0.4N, it is estimated that the severe step of the intermediate transfer belt 120 causes the meandering or an unstable rotation or movement.

Meanwhile, the experiment and the equation result are acquired on the assumption that θ=6.52° all the time regardless of the changes of the value a. While there is some error, it should be understood that such an error is too trivial to affect the effects of the present general inventive concept.

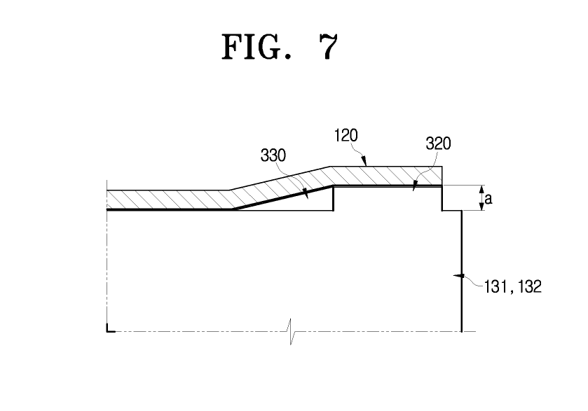

According to another exemplary embodiment, when the step in the height corresponding to the thickness a of the belt pressing member is integrally formed on the support roller, the same results as above can be acquired. Specifically, under the above conditions, when a protrusion 320 is integrally formed on the support rollers 131 and 132 with a height of 70˜230 μm by the thickness a of the belt pressing member above the thickness 20 μm, 40 μm, 60 μm, 80 μm, 100 μm, 200 μm, and 250 μm of the reinforcing film in consideration of the thickness 30 μm of the adhesive, as illustrated in FIG. 7, the magnitude of the tensile force can be obtained based on Equation 1 and the results are produced as illustrated in Table 2. When a taper 330 is integrally formed with the support rollers 131 and 132 and the protrusion 320 to form a gradual curve of the intermediate transfer belt 120 between the left protruding surface of the protrusion 320 and the support rollers 131 and 132, as illustrated in FIG. 7, the damage from the bend of the intermediate transfer belt 120 can be prevented.

As set forth above, the meandering or shifting in the direction B2 can be prevented by disposing the guide rail at one side of a drive belt, such as an intermediate transfer belt. Since a belt pressing member is bonded on the circumference of the support roller at the other side of the drive belt to press the drive belt outward and form a step, the tension force applied to the drive belt by the step prevents the drive belt from leaning to the direction B1.

By canceling the leaning caused by the guide rail formed at one side of the drive belt by means of the belt pressing member formed at the other end of the support roller, the meandering of the drive belt can be effectively suppressed with simplified structure and a small number of parts.

Compared to the related art, meandering can be avoided with a small number of parts, to thus enhance the product reliability.

The belt rotation at the wrong position when the guide rail is used can be prevented, to thereby increase the color image matching.

By blocking the belt rotation at the wrong position by use of the guide rail, cracks or damages to the belt due to the fatigue from the tension unbalance of the right and left sides of the belt can be avoided, to thereby extend the product life.

When a guide rail is used at both sides of the belt, the shortcomings in the adhesion and the adhesion process of the belt and the guide rail can be avoided. Hence, the structure of the image forming apparatus can be improved by applying the guide rail to only one side and preventing the meandering of the drive belt.

By fabricating the belt pressing member as the protrusion integrally formed on the support roller, the manufacture process can be simplified without additional parts by virtue of the effective belt pressure.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A belt shifting preventing device comprising:
a guide rail disposed between one side of a belt and one end of a support roller which supports the belt to guide movement of the belt; and
a belt pressing member disposed at an opposite side of the support roller to compensate for the belt shifting due to the guide rail.

2. The belt shifting preventing device of claim 1, wherein the belt pressing member exerts a tensile force to the belt.

3. The belt shifting preventing device of claim 1, wherein the guide rail comprises:
a guide groove formed in the support roller in a ring shape; and
a guide rib formed in the belt to correspond to the guide groove.

4. The belt shifting preventing device of claim 3, wherein the guide rail further comprises:
a flange formed at one end of the support roller to protrude higher than a circumference of the support roller.

5. The belt shifting preventing device of claim 2, wherein the belt pressing member comprises:
a reinforcing film disposed on the support roller with a certain width to form a step in the other side of the belt; and
an adhesive to bond the reinforcing film onto the support roller.

6. The belt shifting preventing device of claim 5, wherein the reinforcing film is thinner than the belt and thicker than the adhesive.

7. The belt shifting preventing device of claim 5, wherein a height of the belt pressing member is approximately 70˜230 μm.

8. The belt shifting preventing device of claim 5, wherein the reinforcing film has a thickness of approximately 40˜200 μm, and the adhesive has a thickness of approximately 20˜100 μm.

9. The belt shifting preventing device of claim 2, wherein the belt pressing member comprises:
a protrusion integrally formed on the circumference of the support roller to form a step at the other side of the belt.

10. The belt shifting preventing device of claim 9, wherein a thickness of the protrusion is less than the thickness of the belt.

11. The belt shifting preventing device of claim 9, wherein a height of the belt pressing member is approximately 70˜230 μm.

12. A transfer unit comprising:
at least one support roller;
a transfer belt driven and supported by the at least one support roller; and
a meander preventing unit to prevent the transfer belt from meandering to one side with respect to an axial direction of the support roller,
wherein the meander preventing unit comprises:
a belt pressing member disposed at the at least one support roller to prevent the meandering of the transfer belt due to rotation of the support roller.

13. The transfer unit of claim 12, wherein the meander preventing unit further comprises:
a guide rail disposed between the transfer belt and the at least one support roller to guide the movement of one side of the transfer belt.

14. The transfer unit of claim 13, wherein the belt pressing member exerts a tension force to the transfer belt.

15. The transfer unit of claim 13, wherein the guide rail comprises:
a guide groove formed in the support roller in a ring shape; and
a guide rib formed at the transfer belt to correspond to the guide groove.

16. The transfer unit of claim 15, wherein the guide rail further comprises:
a flange formed at one end of the support roller to protrude higher than a circumference of the support roller.

17. The transfer unit of claim 14, wherein the belt pressing member comprises:
a reinforcing film disposed on the support roller with a certain width to form a step in the other end of the transfer belt; and
an adhesive to bond the reinforcing film onto the support roller.

18. The transfer unit of claim 17, wherein the reinforcing film is thinner than the transfer belt and thicker than the adhesive.

19. The transfer unit of claim 17, wherein a height of the belt pressing member is approximately 70˜230 μm.

20. The transfer unit of claim 17, wherein the reinforcing film has a thickness of approximately 40˜200 μm, and the adhesive has a thickness of approximately 20˜100 μm.

21. The transfer unit of claim 14, wherein the belt pressing member comprises:
a protrusion integrally formed on the circumference of the support roller to form a step in the other side of the transfer belt.

22. The transfer unit of claim 21, wherein a thickness of the protrusion is less than the thickness of the transfer belt.

23. The transfer unit of claim 21, wherein a height of the belt pressing member is approximately 70˜230 μm.

24. An image forming apparatus comprising:
a photoconductive medium on which a visible image is formed;
a transfer unit including a transfer belt circumscribing the photoconductive medium and at least one support roller to support the transfer belt to move on an endless track; and
a transfer belt meander preventing device to prevent the transfer belt of the transfer unit from meandering to one side with respect to an axial direction of the support roller,
wherein the transfer belt meander preventing device comprises:
a guide rail disposed between one side of the transfer belt and the support roller to guide the movement of the transfer belt, and
a belt pressing member disposed at the opposite side of the transfer belt to compensate for belt meandering due to the guide rail.

25. The image forming apparatus of claim 24, wherein the belt pressing member exerts a tension force to the transfer belt.

26. The image forming apparatus of claim 24, wherein the guide rail comprises:
a guide groove formed in the support roller in a ring shape; and
a guide rib formed at the transfer belt to correspond to the guide groove.

27. The image forming apparatus of claim 26, wherein the guide rail further comprises:
a flange formed at one end of the support roller to protrude higher than a circumference of the support roller.

28. The image forming apparatus of claim 25, wherein the belt pressing member comprises:
a reinforcing film disposed on the support roller with a certain width to form a step in the other side of the transfer belt; and
an adhesive to bond the reinforcing film onto the support roller.

29. The image forming apparatus of claim 28, wherein the reinforcing film is thinner than the transfer belt and thicker than the adhesive.

30. The image forming apparatus of claim 28, wherein a height of the belt pressing member is approximately 70˜230 μm.

31. The image forming apparatus of claim 28, wherein the reinforcing film has a thickness of approximately 40˜200 μm, and the adhesive has a thickness of approximately 20˜100 μm.

32. The image forming apparatus of claim 25, wherein the belt pressing member comprises:
a protrusion integrally formed on the circumference of the support roller to form a step in the other side of the transfer belt.

33. The image forming apparatus of claim 32, wherein a thickness of the protrusion is less than the thickness of the transfer belt.

34. The image forming apparatus of claim 32, wherein a height of the belt pressing member is approximately 70˜230 μm.

35. An image forming apparatus comprising:
at least one photoconductive medium on which an electrostatic latent image is formed;
a developing unit to develop the electrostatic latent image by transferring and attaching toners onto the electrostatic latent image of the photoconductive medium; and
a transfer unit to superpose and receive a visible image of the photoconductive medium,
wherein the transfer unit comprises:
at least one support roller,
a transfer belt supported and driven by the support roller, and
a meander preventing unit to prevent the transfer belt from meandering to one side with respect to an axial direction of the support roller, and
the meander preventing unit comprises
a belt pressing member disposed on the support roller to prevent the meandering of the transfer belt due to rotation of the support roller.

36. The image forming apparatus of claim 35, wherein the meander preventing unit further comprises:
a guide rail disposed between the transfer belt and the support roller to guide the movement of one side of the transfer belt.

37. The image forming apparatus of claim 35, wherein the belt pressing member exerts a tension force to the transfer belt.

38. The image forming apparatus of claim 36, wherein the guide rail comprises:
a guide groove formed in the support roller in a ring shape; and
a guide rib formed at the transfer belt to correspond to the guide groove.

39. The image forming apparatus of claim 38, wherein the guide rail further comprises:
a flange formed at one end of the support roller to protrude higher than a circumference of the support roller.

40. The image forming apparatus of claim 35, wherein the belt pressing member comprises:
a reinforcing film disposed on the support roller with a certain width to form a step in the other side of the transfer belt; and
an adhesive to bond the reinforcing film onto the support roller.

41. The image forming apparatus of claim 40, wherein the reinforcing film is thinner than the transfer belt and thicker than the adhesive.

42. The image forming apparatus of claim 40, wherein a height of the belt pressing member is approximately 70˜230 μm.

43. The image forming apparatus of claim 40, wherein the reinforcing film has a thickness of approximately 40˜200 μm, and the adhesive has a thickness of approximately 20˜100 μm.

44. The image forming apparatus of claim 35, wherein the belt pressing member comprises:
a protrusion integrally formed on the circumference of the support roller to form a step in the other side of the belt.

45. The image forming apparatus of claim 44, wherein a thickness of the protrusion is less than the thickness of the transfer belt.

46. The image forming apparatus of claim 45, wherein a height of the belt pressing member is approximately 70˜230 μm.

47. A belt pressing member comprising:
a reinforcing film wound around a circumference of one end of a support roller with a certain width and a certain height to form a step to exert a tensile force to one side of a belt to prevent a meandering of the belt which is supported and driven by the support roller.

48. The belt pressing member of claim 47, wherein the reinforcing film is bonded to the support roller using an adhesive, and a height of the reinforcing film bonded onto the support roller is approximately 70˜230 μm including a height of the adhesive.

49. A support roller to support a belt which moves on an endless track, the support roller comprising a protrusion formed in one end with a certain height to form a step to exert a tensile force to one side of the belt to prevent the belt from meandering.

50. The support roller of claim 49, wherein the height of the protrusion is approximately 70˜230 μm.

51. The support roller of claim 50, wherein a guide groove is formed on an opposite side of the protrusion in a ring shape, to which a guide rib formed in a belt is inserted and guided.

52. A method of preventing shifting of a transfer belt, the method comprising:
guiding one side of the belt to rotate within a predetermined region while under tension; and
pressing the belt at an opposite side thereof to compensate for the belt shifting due to the guiding operation.

53. The method according to claim 52, wherein the pressing the belt comprises raising the opposite side of the belt to cause a force on the belt which opposes a force on the belt caused by the guiding one side of the belt.
